(19) United States
(12) Patent Application Publication
(10) Pub. No.: US 2007/0165192 A1
(43) Pub. Date: Jul. 19, 2007

(54) Reduced field angle projection display system

(75) Inventors: Gregory A. Prior, San Jose, CA (US); Gopal Ramachandran, Los Gatos, CA (US)

Correspondence Address: SUGHRUE MION, PLLC, 2100 PENNSYLVANIA AVENUE, N.W., SUITE 800, WASHINGTON, DC, 20037, US

(73) Assignee: Silicon Optix Inc., San Jose, CA (US)

(21) Appl. No.: 11/331,043

(22) Filed: Jan. 13, 2006

(51) Int. Cl. G03B 21/22

(52) U.S. Cl. 353/78

(57) ABSTRACT

A rear projection display system (RPDS) and associated optical system are described with a reduced field angle. The RPDS includes a screen and a housing. The optical system includes a light engine, a first mirror, a second mirror and a Fresnel lens arranged to achieve a thin housing. The light engine is generally disposed in an upper region of the housing, and projects light onto the first mirror, which can be located at a bottom portion of the housing. The first mirror reflects the projected light onto the second mirror, which in turns reflects the light towards the Fresnel lens, which transfers the light onto the screen. A total internal reflection Fresnel lens is used to reduce cost and complexity without sacrificing image quality and housing thinness. An image processing device can also be used to compensate for geometric and optical distortions in the final image displayed on the screen.

### FIELD

Various embodiments are discussed relating to rear projection display systems using reduced field angles.

### BACKGROUND

Conventional rear projection display systems with thin housings have been demonstrated or have been proposed. In order to reduce the depth of the housing, relative to the diagonal dimension of the screen, lower than a certain range, these conventional designs use lens assemblies with very large field angles, some approaching 170°, which are very elaborate and expensive. These lens assemblies enable the projected image to cover the entire screen. However, the light rays impinging on the back of the screen have a large angular range from the top to the bottom of the screen. In order to collimate the beam onto the screen, these conventional designs have to use complex Fresnel lenses having the property that they are reflective for some rays by using total internal reflection, while being refractive for the other rays. Such a so-called “hybrid” Fresnel lens is hard to manufacture and is very expensive.

### SUMMARY

In a first aspect, at least one embodiment of a Rear Projection Display System (RPDS) is described herein. The system comprises a housing; a screen disposed at a front side of the housing; a light engine positioned generally in an upper region of the housing to facilitate heat dissipation, the light engine being adapted to project an off-axis beam of light to form a projected image; a first mirror positioned in a lower region of the housing generally opposite the light engine, the first mirror being adapted to reflect the projected image to form a first reflected image that is reflected upward and away from the screen; a second mirror positioned generally opposite the screen, the second mirror being adapted to reflect the first reflected image to form a second reflected image that is directed towards the screen in an off-axis manner with respect to a screen normal, the second reflected image being formed with light rays having a desired angular range with respect to the screen normal to allow collimation via total internal reflection; and, a total internal reflection Fresnel lens positioned generally parallel and adjacent to the screen, the Fresnel lens being adapted to reflect the light rays of the second reflected image along the direction of the screen normal to form a final image that is displayed on the screen.

In at least some cases, the system can have a D-to-d ratio of at least 6:1, where D is the diagonal length of the screen and d is the thickness of the housing.

In at least some cases, the light engine can be positioned lower than the top of the screen to reduce the amount by which the top of the housing extends above the top of the screen.

In at least some cases, the first mirror can be one of a flat mirror, a cylindrical mirror, a spherical mirror, an aspherical mirror, and a non-rotationally symmetric mirror.

In at least some cases, the second mirror can be one of a flat mirror, a cylindrical mirror, a spherical mirror, and an aspherical mirror.

In at least some cases, the second mirror can be a non-rotationally symmetric mirror.

In at least some cases, the second mirror can have a vertically oriented concave surface and a horizontally oriented surface with a first varying degree of convex curvature on an upper surface that smoothly transitions to a second varying degree of convex curvature on a lower surface for reducing spatial distortion of the final image displayed on the screen.

In at least some cases, the second mirror can have a small degree of horizontal convex curvature on an upper portion and a larger degree of horizontal convex curvature on a lower portion for reducing spatial distortion of the final image displayed on the screen.

In at least some cases, the second mirror can have a slight vertical concave surface.

In at least some cases, the first mirror has first and second portions, and wherein the first portion is disposed further away from the screen than the second portion and the first portion has a smaller radius of curvature than the second portion.

In at least some cases, the first mirror can be a flat mirror, and the second mirror can be vertically and horizontally convex and non-rotationally symmetric.

In at least some cases, the desired angular range is from about 34° to 65°.

In at least some cases, the light engine comprises a light generator to produce a beam of light; at least one micro-display device disposed downstream of the light generator, the at least one micro-display device being adapted to produce a modulated image by modulating the beam of light based on an input image data set; and, a lens assembly disposed downstream of the at least one micro-display device, the lens assembly being adapted to project the modulated image to form the projected image.

In at least some cases, the lens assembly can comprise an aspherical rotationally non-symmetric lens being shaped to compensate for defocusing caused by the second mirror.

In at least some cases, the lens assembly consists of only spherical lens elements.

In at least some cases, the system further comprises an image processor connected to the light engine, the image processor being adapted to correct for geometric and optical distortions in the final image.

In at least some cases, the image processor can be adapted to correct luminance non-uniformity in the final image.

In at least some cases, the image processor can be adapted to perform optical distortion correction for each color component separately to eliminate lateral chrominance distortions in the final image.

In another aspect, at least one embodiment for an optical system is described herein for use in a rear projection display system having a housing and a screen. The optical system comprises a light engine positioned in an upper portion of the optical system, the light engine being adapted to project a beam of light to form a projected image; a first mirror positioned in a lower portion of the optical system, the first mirror being adapted to reflect the projected image to form a first reflected image that is reflected upward and away from the screen; a second mirror positioned to one side of the first mirror, the second mirror being adapted to reflect the first reflected image to form a second reflected image with light rays having a desired angular range with respect to a screen normal of the screen to allow collimation via total internal reflection; and, a total internal reflection Fresnel lens, positioned generally opposite the second mirror, the Fresnel lens being adapted to reflect the light rays of the second reflected image along the direction of the screen normal to form a final image that is displayed on the screen.

In at least some cases, the first mirror can be one of a flat mirror, a cylindrical mirror, a spherical mirror, an aspherical mirror, and a non-rotationally symmetric mirror.

In at least some cases, the second mirror can be one of a flat mirror, a cylindrical mirror, a spherical mirror, and an aspherical mirror.

In at least some cases, the second mirror can be a non-rotationally symmetric mirror.

In at least some cases, the second mirror can has a vertically oriented concave surface and a horizontally oriented surface with a first varying degree of convex curvature on an upper surface that smoothly transitions to a second varying degree of convex curvature on a lower surface for reducing spatial distortion of the final image.

In at least some cases, the second mirror can have a small degree of horizontal convex curvature on an upper portion and a larger degree of horizontal convex curvature on a lower portion for reducing spatial distortion of the final image.

In at least some cases, the second mirror can have a slight vertical concave surface.

In at least some cases, the first mirror can have first and second portions, and wherein the first portion is disposed further away from the screen than the second portion and the first portion has a smaller radius of curvature than the second portion.

In at least some cases, the first mirror can have first and second portions, and wherein the first portion is disposed further away from the screen than the second portion and the first portion has a smaller radius of curvature than the second portion.

In at least some cases, the first mirror can be a flat mirror, and the second mirror is a vertically and horizontally convex and non-rotationally symmetric mirror.

In at least some cases, the desired angular range can be from about 34° to 65°.

In at least some cases, the light engine comprises a light generator to produce a beam of light; at least one micro-display device disposed downstream of the light generator, the at least one micro-display device being adapted to produce a modulated image by modulating the beam of light based on an input image data set; and, a lens assembly disposed downstream of the at least one micro-display device, the lens assembly being adapted to project the modulated image to form the projected image.

In at least some cases, the lens assembly can comprise an aspherical rotationally non-symmetric lens being shaped to compensate for defocusing caused by the second mirror.

In at least some cases, the lens assembly can consist of only spherical lens elements.

In yet another aspect, at least one method is described herein for producing a final image on a screen of a rear projection display system, the display system having a housing. The method comprises:

positioning a light engine in an upper portion of the housing for projecting a beam of light to form a projected image;

positioning a first mirror in a lower portion of the housing for reflecting the projected image to form a first reflected image that is reflected upward and away from the screen;

positioning a second mirror to one side of the first mirror for reflecting the first reflected image to form a second reflected image with light rays having a desired angular range with respect to a screen normal of the screen to allow collimation via total internal reflection; and,

positioning a total internal reflection Fresnel lens generally opposite the second mirror for reflecting the light rays of the second reflected image along the direction of the screen normal to form the final image that is displayed on the screen.

In at least some cases, the method can include providing a non-rotationally symmetric mirror for the second mirror.

In at least some cases, the method can include providing the second mirror with a vertically oriented concave surface and a horizontally oriented surface with a first varying degree of convex curvature on an upper surface that smoothly transitions to a second varying degree of convex curvature on a lower surface for reducing spatial distortion of the final image.

In at least some cases, the method can include providing the second mirror with a small degree of horizontal convex curvature on an upper portion and a larger degree of horizontal convex curvature on a lower portion for reducing spatial distortion of the final image.

In at least some cases, the method can include providing the second mirror with a slight vertical concave surface.

In at least some cases, the first mirror has first and second portions, the first portion being disposed further away from the screen than the second portion and the method can include providing the first portion with a smaller radius of curvature than the second portion.

In at least some cases, the method can include providing a flat mirror for the first mirror, and a vertically and horizontally convex and non-rotationally symmetric mirror for the second mirror.

### BRIEF DESCRIPTION OF THE DRAWINGS

For a better understanding of the embodiments and/or related implementations described herein and to show more clearly how it may be carried into effect, reference will now be made, by way of example only, to the accompanying drawings which show at least one exemplary embodiment and/or related implementation in which:

FIG. 1 is an illustration of a prior art short-throw on-axis Rear Projection Display System (RPDS);

FIG. 2-A is an illustration of a prior art off-axis RPDS using one bending mirror which could be chosen to be flat or curved;

FIG. 2-B is a graphical illustration showing a keystone-distorted projected image that can be produced by the off-axis RPDS of FIG. 2-A on the screen if the bending mirror is flat;

FIG. 2-C is a graphical illustration showing a distortion distribution of the RPDS of FIG. 2-A with a specially curved mirror chosen for the bending mirror to correct keystone distortion;

FIG. 2-D is a graphical illustration showing a distribution of incidence angles for light rays impinging on the back of the screen of the RPDS of FIG. 2-A;

FIG. 3-A is an illustration of another prior art off-axis RPDS using two mirrors, which can be chosen to be flat or curved;

FIG. 3-B is a graphical illustration showing a keystone-distorted projected image that can be produced by the off-axis RPDS of FIG. 3-A on the screen if the bending mirror is flat;

FIG. 3-C is a graphical illustration showing a distortion distribution of the off-axis RPDS of FIG. 3-A with the large bending mirror specially curved;

FIG. 3-D is a graphical illustration showing the distribution of incidence angles for light rays impinging on the back of the screen of the RPDS of FIG. 3-A;

FIG. 4 is a cross-sectional view showing the transition region of a so-called “hybrid” reflective and refractive Fresnel lens used in prior art RPDS units;

FIG. 5 is an illustration of an exemplary embodiment of a novel off-axis RPDS;

FIG. 6 is a graphical illustration showing a surface profile of an exemplary first mirror that can be used with the RPDS of FIG. 5;

FIG. 7 is a graphical illustration showing a surface profile of an exemplary second mirror that can be used with the RPDS of FIG. 5;

FIG. 8-A is a graphical illustration showing a keystone-distorted projected image that may be produced by the off-axis RPDS of FIG. 5 on the screen if both mirrors are flat (in addition to the keystone distortion, the image is not magnified enough to fill the screen);

FIG. 8-B is a graphical illustration showing a keystone-distorted projected image that may be produced by the off-axis RPDS of FIG. 5 on the screen if the large second mirror is flat and the smaller first mirror is curved with a profile chosen to substantially fill the upper portion of the screen with a displayed image (the keystone distortion remains);

FIG. 8-C is an illustration of the projected image that may be produced by the off-axis RPDS of FIG. 5 on the screen if both mirrors are curved with certain exemplary desirable profiles;

FIG. 9-A is a cross-sectional view of an exemplary TIR Fresnel lens that can be used with the RPDS of FIG. 5 and shows the resulting operation when all rays are in a desired angular range;

FIG. 9-B is a cross-sectional view of an exemplary TIR Fresnel lens that can be used with the RPDS of FIG. 5 and shows the resulting operation when some rays are outside of a desired angular range;

FIG. 10 is a graphical illustration of the distribution of incidence angles for light rays impinging on the back of the screen of the RPDS of FIG. 5;

FIG. 11 is a block diagram of an exemplary implementation of the RPDS of FIG. 5 showing the flow of digital data and light; and, FIG. 12 is a block diagram of an exemplary implementation of an image processor that can be used with the implementation shown in FIG. 11.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments and/or implementations described herein. However, it will be understood by those of ordinary skill in the art that the embodiments and/or implementations described herein may be practiced without these specific details. In other instances, well-known methods, procedures and components have not been described in detail so as not to obscure the embodiments and/or implementations described herein. Furthermore, this description is not to be considered as limiting the scope of the embodiments described herein, but rather to describe the structure and operation of the various embodiments and/or implementations described herein.

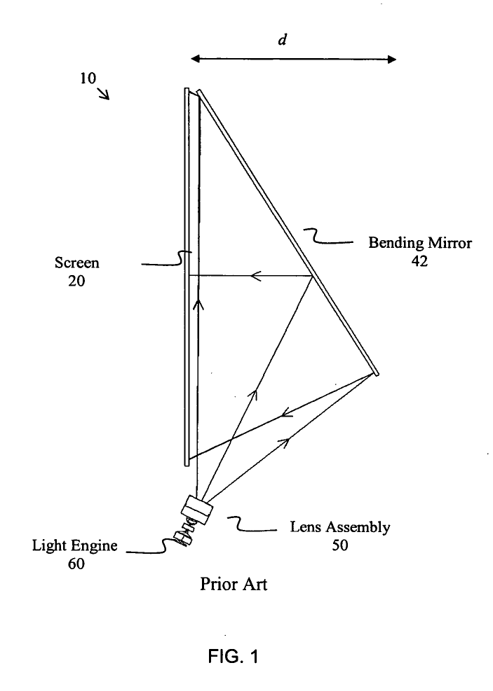

The general idea behind a Rear Projection Display System (RPDS) is demonstrated by the prior art short-throw on-axis RPDS 10 shown in FIG. 1. A bending mirror 42 folds the light path, giving rise to a conventional thickness housing. It is well known that, for an RPDS to comply with desirable commercial standards, it must have a thin and compact housing. This “compactness” is quantified in terms of the “diagonal to depth ratio” or D-to-d ratio. The D-to-d ratio of a projection system is given by the diagonal length D (not shown) of a screen 20 divided by the thickness of the housing or projection distance d (shown in FIG. 1). The diagonal D is measured from the opposite corners of the screen 20. The D-to-d ratio is given by equation 1.

$$D \text{-} to \text{-} d Ratio = \frac{D}{d} \qquad ( 1 )$$

Conventional thin-housing RPDS designs usually have a D-to-d ratio of about 3:1. However, recently, a number of conventional ultra-thin housing RPDS have been demonstrated or have been proposed that use very wide-angle lenses and/or curved mirrors to achieve a D-to-d ratio of about 6:1 to 8:1 or more. One such application is described in United States Patent Application Publication No. 20040141157 assigned to Silicon Optix Inc. However, one problem that is common with many of these designs is the requirement for a complex Fresnel lens located at, or near the screen which should collimate a wide range of input incident angles. These angles can range from around 0° to more than 60°, necessitating a Fresnel lens which has both refractive and reflective blades. This combination requires a complex and expensive design. The wide-angle lenses used in such designs are also expensive, requiring many elements to correct for optical and geometric distortions and lateral color aberration, among other corrections.

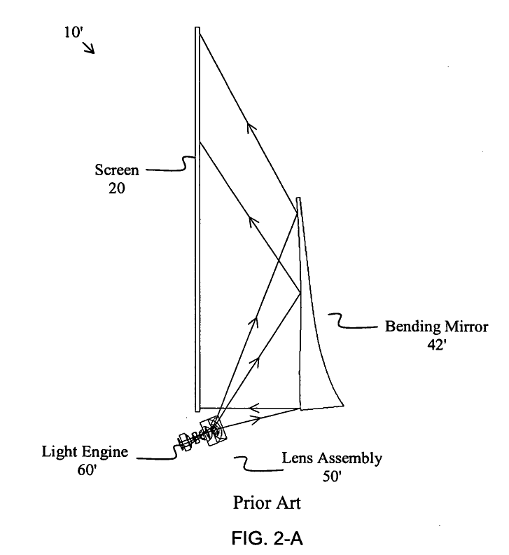

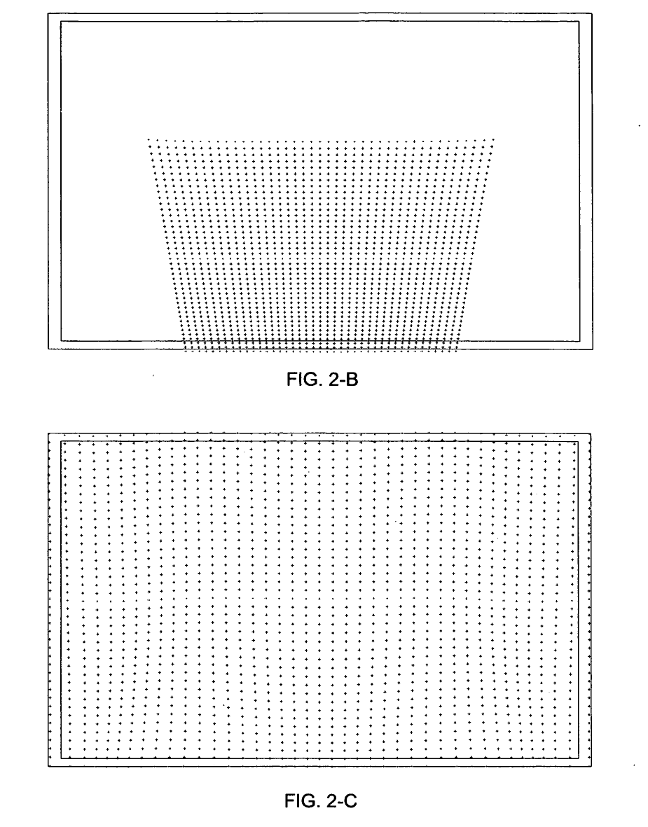

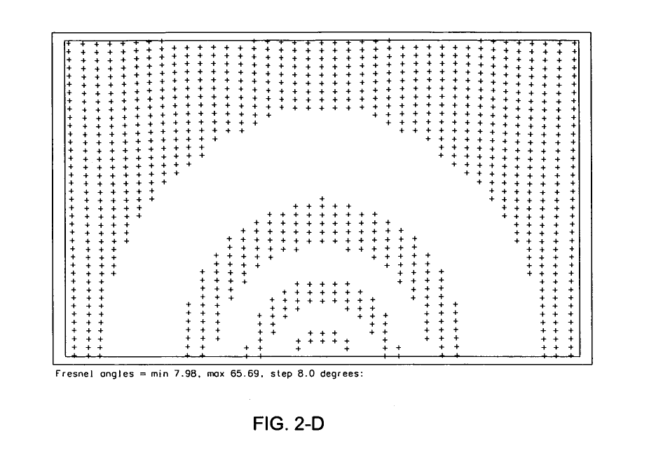

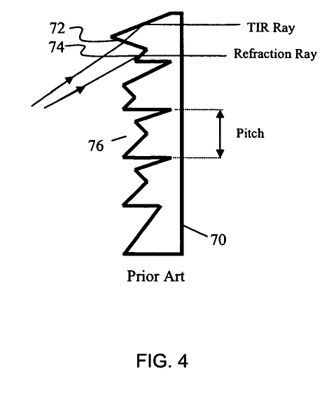

Some prior art ultra-thin RPDS designs use a very wide-angle lens and a lens offset to make the housing thinner as exemplified by the prior art RPDS 10′ shown in FIG. 2-A. These lens assemblies can have a large number of optical elements and are very expensive. In such a system, the Fresnel angles (i.e. the angles of the light rays impinging on the screen 20 with respect to vertical) can span from a minimum of 5° to 10° to a maximum of at least 70°. This requires a special Fresnel lens (See FIG. 4 for an example) which is refractive for angles up to around 30°, then reflective using total internal reflection (TIR) for angles greater than about 30° up to the maximum angle. TIR Fresnel lenses typically work from around 30° to around 80°.

In FIG. 2-A, the RPDS 10′ includes an elaborate lens assembly 50′ consisting of many optical elements that are used to project the image onto the screen 20 via reflection from a bending mirror 42′. The wide, angular spread of the beam is crucial in order to cover the whole screen area as shown in the figure.

FIG. 2-B is an illustration of the keystone-distorted projected image that can be produced by the off-axis RPDS 10′ on the screen 20 if the bending mirror 42′ is flat. This keystone distortion can be partially corrected with the use of a proper shaped for the curved mirror 44′, in which case the distortion distribution can be as shown in FIG. 2-C.

The corresponding distribution of the incident angles of the light rays forming the final image that arrives at the screen 20 is shown in FIG. 2-D. Since a Fresnel lens is typically used to collimate these angles, they can also be called Fresnel angles.

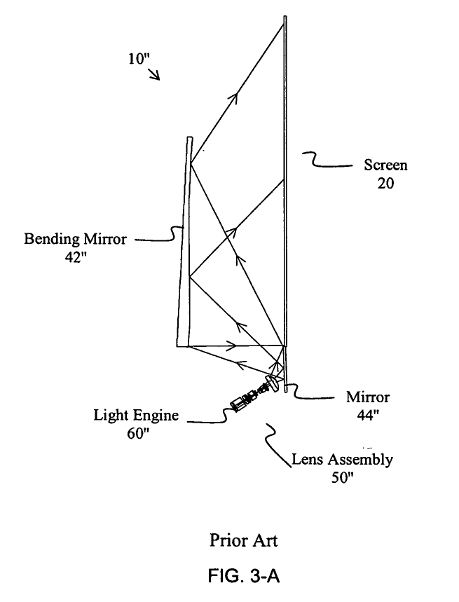

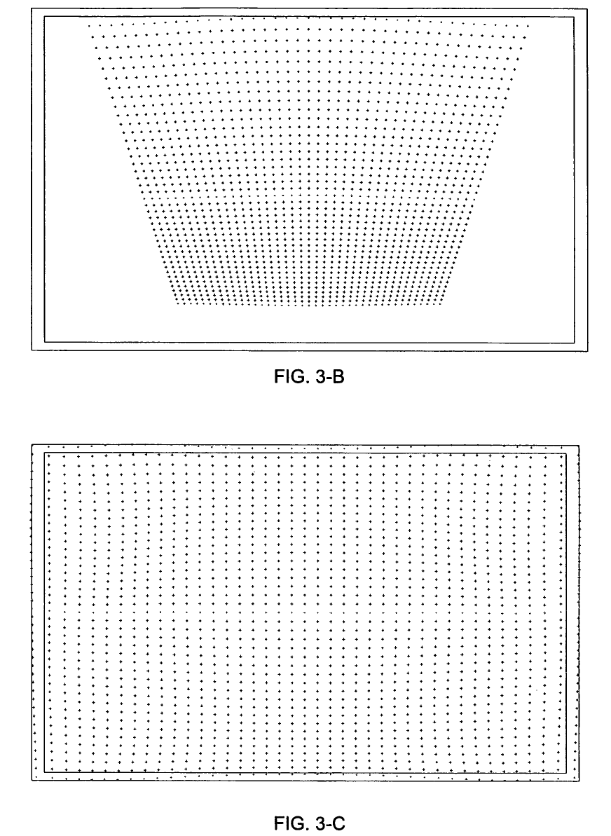

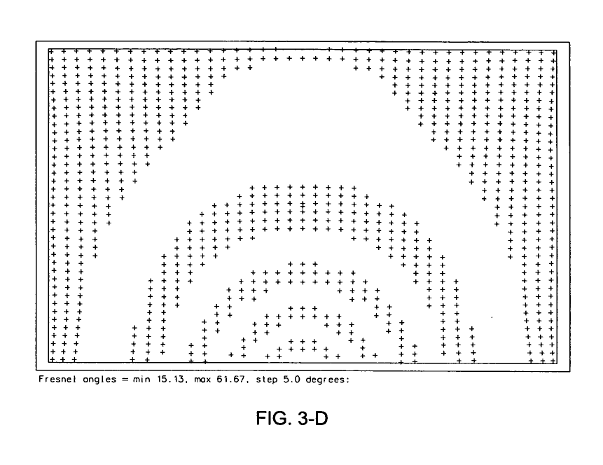

FIG. 3-A is an illustration of another prior art RPDS 10″, wherein two different mirrors 42″ and 44 are used to reflect the projected image onto the screen 20. In this example, a complex lens assembly 50″ is also used, right after the light engine 60″, to spread the beam in order to cover the entire screen 20.

FIG. 3-B is an approximation of the image projected onto the screen when two flat mirrors are used. The image can be partially corrected for the geometric distortion with the use of proper curved mirrors, in which case the distortion distribution is shown in FIG. 3-C. The corresponding distribution of the Fresnel angles is given in FIG. 3-D.

In these prior art RPDS examples, as well as other similar prior art devices, in order to make the housing depth ultra-thin, it is necessary to spread out the beam significantly to substantially cover the whole screen area. This in turn causes a wide range of incident angles for the light rays impinging onto the back of the screen to form a projected image. Once the beam is spread onto the screen it spans an angular distribution of near 0° to about 60-70°. In order to collimate such a beam onto the screen, a complex combination reflection and refraction Fresnel lens is needed.

Referring now to FIG. 4, shown therein is an illustration of the shape of the transition region of an exemplary prior art hybrid reflective and refractive Fresnel lens 70. As can be seen from this figure, there are different blades for total internal reflection (TIR), one of these blades is labeled as 72, and refraction of light, one of these blades is labeled as 74, in each pitch (one of which is labeled as 76) and consecutive pitches of the lens 70 do not follow a specific pattern. This structure is very complicated and, as such, it is expensive to design such a Fresnel lens.

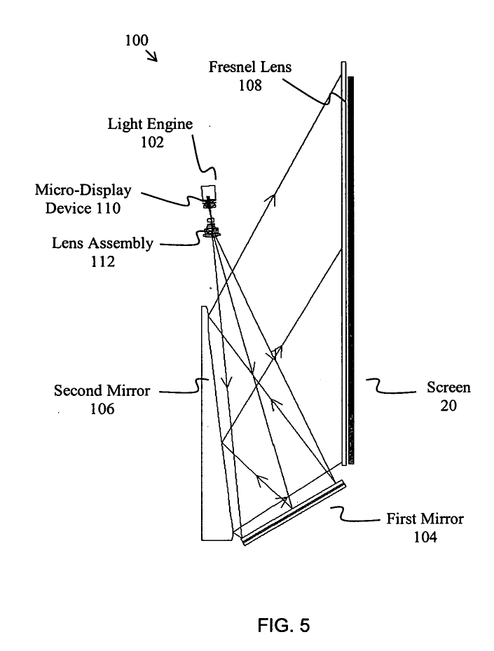

Referring now to FIG. 5, there is shown an exemplary embodiment of a novel RPDS 100. It comprises a light engine 102, a first mirror 104, a second mirror 106, a Fresnel lens 108, and a screen 20. The light engine 102 includes one or more micro-display devices 110 and a lens assembly 112. The structure is held in a housing that is not shown. The light engine 102, first mirror 104, second mirror 106, and Fresnel lens 108 can be considered to be an optical system. The arrangement and the geometry of these optical components and the screen can be selected to provide a D-to-d ratio of at least 6:1.

The light engine 102 is generally located at an upper portion of the housing of the RPDS 100. In the example illustrated in FIG. 5, the light engine 102 is positioned without protruding above the screen 20. The position of the light engine 102 at an upper portion of the housing of the RPDS 100 allows convective heat dissipation. In a conventional RPDS, the light engine is positioned generally at the bottom of the housing, making it difficult for the heat to dissipate. Another problem with heat dissipation for conventional RPDS designs is the rising of the heat from the light engine through the RPDS system which may deform various optical elements in the system and cause image distortion, focus problems and other visible artifacts in the final image that is displayed on the screen 20.

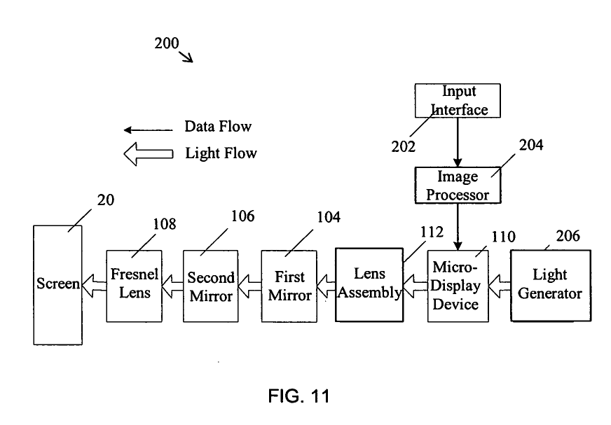

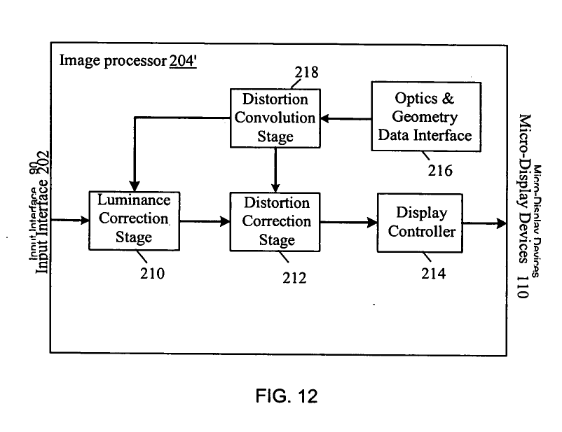

A beam of light is generated by an illumination subsystem of light engine 102 (see FIG. 11 for an example) and is then modulated by the micro-display device 110. Depending on the technology of the micro-display device 110, the beam of light from the illumination subsystem (not shown) can be modulated during transmission through, or reflection from the micro-display device 110. Examples of different micro-display device technologies include transmissive designs, such as a High Temperature PolySilicon (HTPS) LCD micro-display device, for example, or reflective designs, such as DMD and LCOS micro-display devices, for example. Single panel or three panel micro-display device based light engines can also be used, so in some implementations the light engine 102 can include more than one micro-display device. The micro-display device 110 receives digital input image data from an input interface (see FIG. 11 for example) and uses the data to modulate a rectangular-shaped beam of light in order to produce a final image which is eventually displayed on the screen 20.

A first image is projected by the lens assembly 112, which is positioned right after the micro-display device 110, onto the first mirror 104. As a result of the design of the RPDS 100, the lens assembly 112 does not need to be complex. Accordingly, a smaller number of lens elements can be used in the lens assembly 112. The magnification of the final image is achieved via a long light path and a reduced field angle (i.e., the range of angles of the beams of light in the projected image) used in the design of the RPDS 100, which also inherently reduces aberrations including distortion and lateral color shifts (these aberrations are more prevalent in prior art lens systems).

More particularly, the field angle is the vertex angle of the beam of light that emerges from the lens assembly 112. As this beam diverges, the image that it can create on any screen that this beam intercepts is larger the further away the screen is from the lens assembly 112. If the lens assembly 112 is close to the screen, this beam must diverge greatly in a short distance to fill the screen completely. Accordingly, the length of the optical path and the size of the displayed image determine the field angle. The reason that the field angle is reduced in the RPDS 100 is because the optical path is so long. Accordingly, a reduced field angle is enough to provide a large image on the screen 20 since the light beam travels a long distance through various reflections.

In addition, the smaller the field angle, the smaller the active area of the lens assembly 112 that is being used, and this reduces aberrations because there is not as severe a change in light incident angles on the glass surfaces of the lens elements of the lens assembly 112 from the central part of the lens elements to the outer parts of the lens elements. A wide-angle lens uses most of the lens surface, and the differences in light incident angles on different parts of the lens causes big variations in the optical path of individual light rays emerging from the lens. Some rays go through more glass than others, some rays hit the glass at far different angles than other rays, and so on. This is avoided in the RPDS 100.

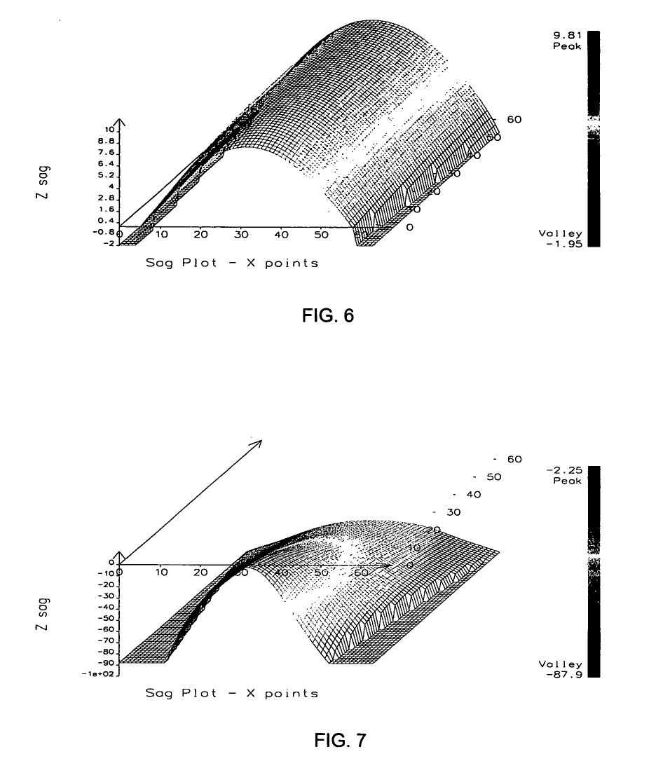

In the exemplary embodiment shown in FIG. 5, the projected beam from the light engine 110 travels down the housing of the RPDS 100 nearly parallel to the second mirror 106. The first mirror 104 is positioned with one end near the bottom of the screen 20 and another end away from and slightly lower than the bottom of the screen 20. The portion of the projected light beam striking the first mirror 104 in a region that is further away from the bottom of the screen 20 reflects to a lower region of the second mirror 106 and impinges on a lower portion of the screen 20. In contrast, the portion of the projected light beam that strikes a region of the first mirror 104 that is closer to the bottom of the screen 20 travels much further to an upper region of the screen 20 after being reflecting from an upper region of the second mirror 106. This has an impact on the shape of the profile chosen for the first mirror 104 in order to magnify the projected beam. Accordingly, the profile of the first mirror 104 can be chosen to have a smaller radius of curvature in a region that is further away from the bottom of the screen 20 (since it must magnify the projected image traveling to the lower portion of the screen 20 with a short optical path). The profile of the first mirror 104 can be less curved in the region that is closer to the bottom of the screen 20 since the much longer transit distance of the portion of the projected beam of light that reflects off of this region of the first mirror 104 will allow it to adequately fill the upper region of the screen 20. FIG. 6 illustrates an exemplary implementation of the first mirror 104 corresponding to these desirable structural features.

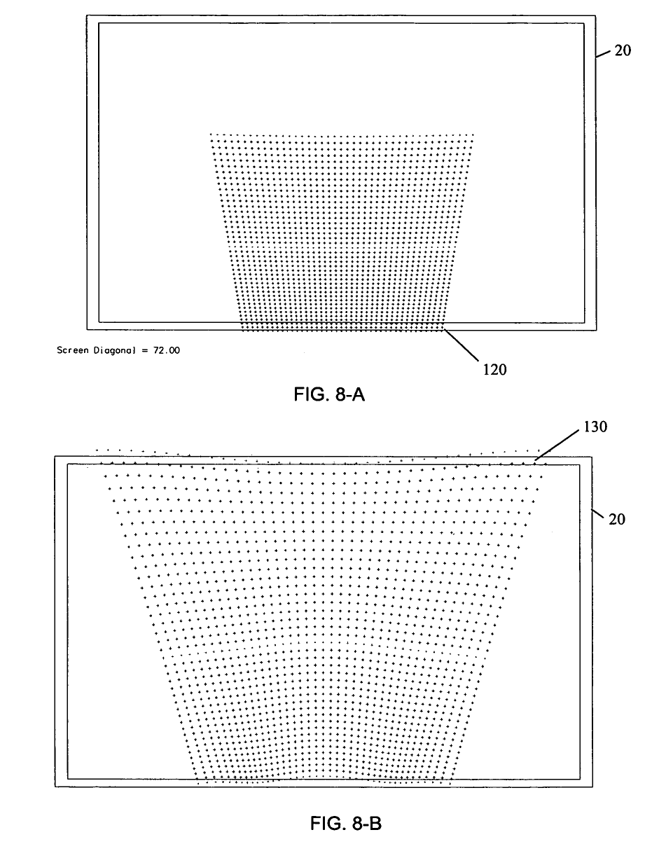

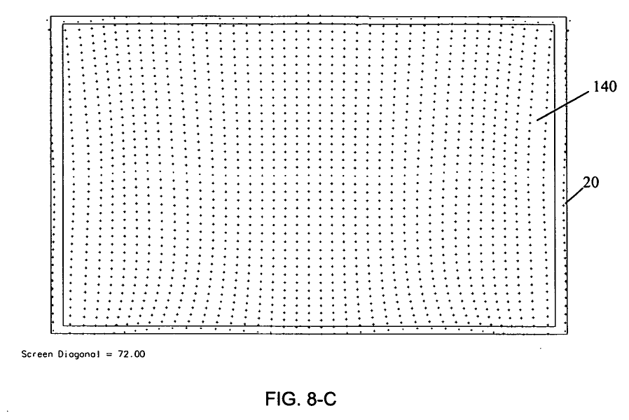

The first mirror 104 is used in combination with the second mirror 106 to correct for the geometric distortions of the final image that is to be displayed on the screen 20. FIG. 8-A shows an example of a keystone-distorted projected image 120 that can be produced by the off-axis RPDS 100 of FIG. 5 on the screen 20 if both mirrors 104 and 106 are flat. In addition to the keystone distortion, the image 120 is not magnified enough to fill the screen 20 in the horizontal and vertical directions in this example.

FIG. 8-B shows a keystone-distorted projected image 130 that can be produced by the off-axis RPDS 100 of FIG. 5 on the screen 20 if the second mirror 106 is flat and the first mirror 104 is curved with a quasi-cylindrical profile similar to that shown in FIG. 6, chosen to substantially fill the upper portion of the screen 20 with the displayed final image. Since the first mirror 104 is used only for magnification, the keystone distortion remains.

FIG. 8-C is an illustration of a projected image 140 that can be produced by the off-axis RPDS 100 of FIG. 5 on the screen 20 if both mirrors 104 and 106 are curved with profiles chosen to be similar to those shown in FIG. 6 for the first mirror 104 and in FIG. 7 for the second mirror 106. The keystone distortion has been largely corrected, and the image 140 is sized to fit the screen 20 exactly with no visual distortion.

FIG. 7 is an illustration of an exemplary embodiment for the surface curvature or profile of the second mirror 106. As seen in the figure, the second mirror 106 has been designed to correct for the geometric distortions, most of which result from the off-axis nature of the RPDS 100. Some other optical and geometric distortions are also caused by the other optical elements in the RPDS 100.

Referring now to FIG. 8-B, the projected image 130 reflected off of the first mirror 104, when it is flat, needs to expand slightly at the upper portion of the screen 20 to cover the whole horizontal width of the screen 20. In addition, the lower portion of the image 130 needs to expand much more horizontally to cover the horizontal width of the lower portion of the screen 20. Accordingly, the second mirror 106 can be designed to have a slightly horizontally convex upper portion to slightly expand the image 130 to fit across the entire width of the upper portion of the screen 20. The second mirror 106 can also be designed to have a much more convex lower portion to expand the image to horizontally fit the width at the lower portion of the screen 20. As seen in FIG. 8-B, the transition between the top of the mirror 106 and the bottom of the mirror 106 is smooth and gradual, corresponding to the keystone shape of the uncorrected image.

In the vertical direction, as seen from FIG. 8-B, the image 130 needs to be shrunk slightly in order to fill the height of the screen 20. To achieve this, as seen in FIG. 7, the second mirror 106 can be designed to have a slight vertical concave surface to slightly shrink the image 130 in the vertical direction to match the height of the screen 20. Unlike the horizontal expansion of the image 130 which is dramatically different for the upper and lower portions of the image 130, the vertical shrinking of the image 130 is symmetric. The second mirror 106 therefore, in this exemplary implementation, has an axis of symmetry extending from an upper middle portion to a lower middle portion. It is clear that in this exemplary implementation, the second mirror 106 is not spherically or even rotationally symmetric.

In at least some implementations of the RPDS 100, the vertical position of the light engine 102 can be adjusted such that the keystone effect from the off-axis projection gives rise to an upper portion of the final image with exactly the same width as the upper portion of the screen 20. In these exemplary implementations, the upper portion of the second mirror 106 can be nearly flat which reduces the complexity of the design and manufacture of the second mirror 106.

One of the functions of the first mirror 104, in the exemplary embodiment of the RPDS 100, is to expand the final image to substantially cover the full dimensions of the screen 20. Accordingly, in at least some implementations, the first mirror 104 does not need to be used to correct for distortions in the final image. As such, in at least some implementations, the design of the mirror 104 can be simplified to have a cylindrical shape. A cylindrical shape achieves expansion of the final image in the horizontal direction, which is longer than the vertical dimension of the screen 20 as is the case for most display screens. Furthermore, a cylindrical mirror is much easier and cheaper to make than a generally curved mirror. This is due to the fact that the surface curvature of a cylinder is zero. The surface curvature is defined as the product of the two line curvatures in the principal directions of that surface and, for a cylinder, one of the two line curvatures is zero. Another more physical way to look at this is that a cylinder can be built from bending a rectangle in one direction. A rectangle and a cylinder are therefore said to be topologically equivalent. Choosing a cylindrical surface for the first mirror 104 has advantages in reduced cost since a cylindrical mirror requires no special machining or molding. It can be fabricated by using suitable mandrels, or by coating cylindrical surfaces. Accordingly, choosing a cylindrical shape for the first mirror 104 is advantageous in terms of reduced cost, increased manufacturing ease and increased robustness.

Selections of various positions for the first and second mirrors 104 and 106, various surface profiles for the first and second mirrors 104 and 106, and selecting various prescriptions for the lens assembly 112 can yield different system goals. For example, the lens assembly 112 can be comprised of all-spherical lens elements, for low cost and short assembly times. However, this can entail more complex curved profiles for the mirrors 104 and 106, although the profile curvatures of the mirrors 104 and 106 selected to achieve the desired overall effect can be distributed between the two mirrors 104 and 106 in different ways. In other implementations, the lens assembly 112 can include an aspherical rotationally non-symmetric lens that is shaped to compensate for any defocusing that is caused by the second mirror 106.

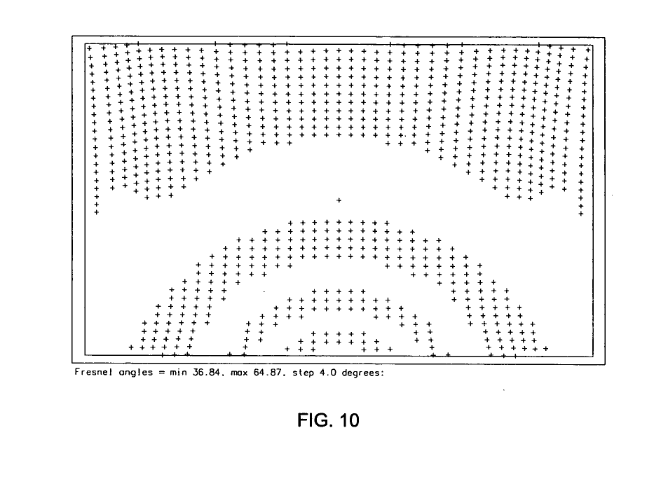

The goal of the optical elements 102, 104, 106, 110 and 112 of the RPDS 100 is to eventually redirect a distortion compensated projected image towards the Fresnel lens 108 with a desired angular distribution, which allows for the collimation of the projected image with a TIR Fresnel lens. In the exemplary embodiment of FIG. 5, the desired angular distribution is from about 34° to about 65° as shown in FIG. 10 which is desirable for collimating the reflected projected light beam in the normal direction of the screen 20 when a TIR Fresnel lens is used. Such a Fresnel lens does not need combination reflective and refractive blades, which reduces cost, and can produce a high quality final image on the screen 20.

It is important to note that the exemplary embodiments of the first and second mirrors 104 and 106 previously mentioned represent only one combination of profile curvatures or shapes for the two mirrors 104 and 106 so that together the mirrors 104 and 106 reflect the rays of the final image within the desired angular range. Other configurations for the shapes of the mirrors 104 and 106 can be used without departing from the scope of the exemplary embodiments described herein. For example, the first mirror 104 can have a flat shape. In this case, the second mirror 106 can be a convex mirror in the vertical and horizontal directions while keeping its non-rotationally symmetric structure. The extra curvature of the mirror 106 in this case compensates for the flatness of the first mirror 104. Other possible combinations all fall within the scope of the exemplary embodiments described herein as long as the combinations project rays of reflected light towards the Fresnel lens 108 that fall within the desired angular range. In at least some implementations, the combination can also be selected to correct for the geometric distortions of the system. For instance, the first mirror 104 can be a flat mirror, a cylindrical mirror, a spherical mirror, an aspherical mirror, or a non-rotationally symmetric mirror, and the second mirror 106 can be a flat mirror, a cylindrical mirror, a spherical mirror, an aspherical mirror, or a non-rotationally symmetric mirror, as long as the combination of the first and second mirrors 104 and 106 produce the desired effects discussed above.

Different kinds of complex Fresnel lenses have been developed in prior art thin-housing RPDS designs. One prior art approach uses a hybrid Fresnel lens, which varies in function from behaving like a conventional large diameter refractive lens on one side to behaving like a mirror (using TIR, or Total Internal Reflection). In the transition region between the two extremes, this type of Fresnel lens uses both reflection and refraction. The edges of the grooves are very complex in order to perform this function. The transition is gradual over the entire extent of this type of Fresnel lens. Small deflections in this type of Fresnel lens can cause very large shifts in the active area of the Fresnel lens for any specific light beam impinging on the lens. These shifts can result in ghost images and brightness variation. To prevent this, one can use an optically perfect rigid glass sheet, both sides of which are parallel to within optical tolerances, to which the Fresnel lens is attached. The attachment is done by using an optical-grade adhesive that is transparent and has optical and thermal properties matching that of the glass and the Fresnel lens. This optical-grade adhesive is very expensive and so is the rigid glass sheet.

Another prior art approach uses a dual Fresnel lens which has two grooved surfaces, on opposite sides. This structure needs to be very rigid in order to prevent artifacts due to flexing of the lens. One way to achieve this is to place rigid glass in the center and attach two Fresnel lens components, having the grooved surfaces, on the opposite sides of the rigid glass. The attachment is again done by using an expensive optical-grade adhesive that is transparent and has optical and thermal properties matching that of the glass and the two Fresnel lens. This prior art structure is again expensive and needs sensitive alignment.

TIR Fresnel lenses, however, are made from plastic polymers, fabricated in a UV-sensitive process, and can be made at very similar cost to conventional refractive Fresnel lenses. Both linear and circular TIR Fresnel lenses have been developed commercially. Circular TIR Fresnel lenses are most suitable for use with the RPDS 100, and associated or alternative embodiments and/or implementations, because these Fresnel lenses are able to collimate light beams falling on their surface after originating from a small near point source, namely, the exit pupil of a lens assembly. Linear TIR Fresnel lenses work best with a linear image source.

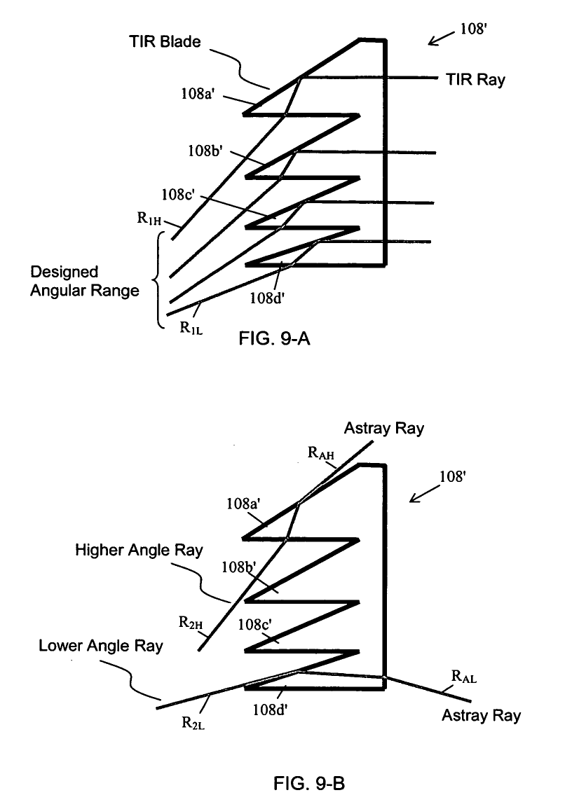

FIGS. 9-A and 9-B are illustrations of an exemplary circular TIR Fresnel lens 108′ that can be used with the RPDS 100 and related or alternative embodiments and/or implementations. The structure of the TIR Fresnel lens 108′ is much simpler than the hybrid reflective and refractive Fresnel lens 70 shown in FIG. 4. As seen in FIG. 9-A, the rays of light impinge on the blades 108a′-108d′ of the TIR Fresnel lens 108′ with an angular range of 30 to 65° with respect to the direction of the screen normal, which is the horizontal direction in this figure. The structure of the Fresnel lens 108′ in this example has a gradation wherein each inclined TIR blade is steeper on the upper portions, corresponding to a higher angle of the incoming rays with respect to the screen normal. At each blade, an incoming ray of light arrives at the horizontal air-glass interface, where it undergoes refraction toward the direction of the interface normal (i.e. the interface between the air and the vertically straight glass edge of the Fresnel lens 108′). The refracted rays then undergo total internal reflection at the air-glass interface of the inclined blades and exit the Fresnel lens 108′ close to the horizontal. Accordingly, the gradually increasing inclination of the angles of the top slopes of consecutive inclined blades causes each ray to be very close to the screen normal when it exits the Fresnel lens 108′. As a result, the rays do not suffer a change of direction through further refraction. This is advantageous since any stray refraction of an exiting ray will further divert that ray away from the screen normal causing so-called “ghost” images.

Referring once again to FIGS. 9-A and 9-B, exemplary paths for light rays are shown which occur when the Fresnel lens 108′ is used with the RPDS 100′ or an alternative embodiment. The lowest ray arrives at the Fresnel lens 108′ at the lowest angle in the desired angular range with respect to the screen normal. It can be seen from FIG. 9-B that if the angle of the incoming ray R_{2L} is slightly lower than that of the lowest depicted ray R_{1L} in FIG. 9-A, the ray may be parallel to or may have a lower angle than the corresponding inclined blade with respect to the screen normal. Such a ray then undergoes a refraction on the inclined blade and becomes an astray ray R_{AL} as shown in FIG. 9-B. On the other hand, if the incoming ray angle is slightly higher than that shown for the highest ray R_{1H} of FIG. 9-A, the ray refracts from the horizontal blade, but it no longer experiences total internal reflection at the inclined blade. The angle of the ray direction with respect to the interface normal of the inclined blade is too small to produce a total internal reflection. Instead, the ray refracts, exiting that blade with a slight angle with respect to the interface tangent as shown for rays R_{2H} and R_{AH} of FIG. 9-B.

Referring now to FIG. 11, a block diagram of an exemplary implementation of the RPDS 200 is shown in which an image processor 204 can be used to correct for geometric and optical distortions of the displayed final images. Digital input image data is first received by the image processor 204 via an input interface 202. Even though the first and second mirrors 104 and 106 can correct for most of the distortion caused by off axis projection, there is still some residual distortion as shown in FIG. 8-C which can be addressed by the image processor 204. The image processor 204 is coupled with the micro-display device 110 and the input interface 202. The image processor 204 drives the micro-display device 110 via an interface chip (not shown). The image processor 204 receives digital input image data and distortion parameters from the input interface 202. The distortion parameters characterize all optical and geometric distortions of the system 200. Based on the distortion parameters, the image processor 204 generates a transformation from the input image pixel space to the output image pixel space, which pre-compensates for the geometric and optical distortions of the system 200. The image processor 204 then applies the transformation to the digital input image data to produce pre-compensated input image data. The micro-display device 110 then produces an image by modulating a light beam, provided by a light generator 206, according to the pre-compensated input image data. When an image is projected through the lens assembly 112, off of the first and second mirrors 104 and 106, the pre-compensation provided by the transformation eliminates the residual optical distortions due to these optical elements and the residual (uncorrected from the optics) geometric distortions due to off-axis projection.

One way to illustrate the function of the image processor 204 is to denote the effect of the whole distortion, represented by the distortion parameters, as a distortion transformation function F. The pre-compensation transformation of the image processor 204 is then given by the inverse transformation function F¹. The following relation in equation 2 then demonstrates the overall result due to the pre-compensation performed by the image processor 204.
Displayed Image=F(F⁻¹(Input Image))=Input Image (2)

The input image data is basically a 2D array of pixels. The image processor 204 re-samples each pixel in the input image data and pre-compensates for the optical and geometrical distortions by applying the transformation function F⁻¹. An exemplary implementation of the transformation function F⁻¹ includes the use of surface functions parameterized in terms of the distortion parameters.

The geometric distortions are mostly caused by the off-axis projection which causes a keystone effect. FIGS. 2-B and 3-B provide illustrations of exemplary uncorrected keystone distorted images caused by off-axis projection. Appropriate surface profiles, as previously discussed, can be chosen for the first and second mirrors 104 and 106 to correct for the bulk of the keystone distortion. However, the image processor 204 can also be used to pre-compensate for any residual keystone distortion.

The optical distortions are primarily due to deviations from paraxial lens theory (which gives rise to pincushion/barrel distortion), lens imperfections and mirror imperfections. These distortions are functions of the optical path length of the light going though different portions of the optical elements. The intensity of light of the displayed final image falling on a point or section of the screen varies, especially falling off in brightness at the corners of the screen. This leads to brightness variations within the displayed final image. In an off-axis projection system, there are more pronounced differences in the path length traversed by light rays impinging at the upper portion of the screen versus the lower portion of the screen. Consequently, the brightness variations are greater for an off-axis projection system than for an on-axis projection system. To achieve proper brightness distribution on the screen, the image processor 204 can adjust the brightness of each pixel to offset the brightness variations.

It should be noted that many optical distortions are due to wavelength dependent refractive index variations. As such, in at least some implementations, the image processor 204 can process different colors separately. For each color component of the input image, a separate transformation function can be used to pre-compensate for the distortions suffered. In terms of the transformation function in an RGB color space, this corresponds to three distortion compensation transformation functions F_{R}⁻¹, F_{G}⁻¹, and F_{B}⁻¹ corresponding to three distortion transformation functions F_{R}, F_{G}, and F_{B}. In at least some implementations, the image processor 204 can perform distortion correction for each color component separately to eliminate lateral chrominance distortions in the final image.

Referring once more to FIG. 11, there is shown an illustration of the flow of digital image data, and the flow of light, in the exemplary implementation of the RPDS 200. The image processor 204 obtains digital input image data and parameters for optical and geometrical distortions of the system 200 from the input interface 202. The image processor 204 then compensates for the distortions and produces digital output image data. This data is used by the micro-display device 110 to modulate the light that it transmits or reflects. This modulated light is projected and focused by the lens assembly 112 and reflected off of the first mirror 104 and the second mirror 106. The reflected light is then collimated by the Fresnel lens 108 and redirected to be substantially perpendicular to the screen 20 where the final image is displayed.

Referring now to FIG. 12, there is shown an illustration of the structure and function of an exemplary implementation of an image processor 204′. The image processor 204′ can include a luminance correction stage 210, a distortion correction stage 212, a display controller 214, an optics and geometry data interface 216 and a distortion convolution stage 218. The distortion convolution stage 218 obtains a parametric description of the geometric and optical distortions from the optics and geometry data interface 216. The distortion convolution stage 218 then combines the distortion parameters and produces two outputs, one of which is sent to the luminance correction stage 210, and the other is sent to the distortion correction stage 212. The luminance correction stage 210 receives input image data from the input interface 202 and adjusts the luminance values of the input image data to compensate for luminance non-uniformities, provided by data from the distortion convolution stage 218, and produces luminance-corrected input image data. The distortion correction stage 212 then resamples the luminance-corrected input image data to compensate for geometric and optical distortions.

Chromatic aberrations arise from refractive index variations which are wavelength dependent. Accordingly, in at least some implementations, the image processor 204 can perform distortion correction separately for red, green, and blue color components of the input image data. By separately processing different color components, lateral color aberrations are corrected. In these implementations, the optics and geometry data interface contains separate sets of distortion parameters for different color components and the sets of input image data corresponding to the different color components are processed separately by the luminance correction stage and the distortion correction stage.

For the various embodiments and implementations of the novel RPDS described herein, the optical path length of the projected light from the lens assembly to the first mirror is long. This allows for image magnification without severe lateral color shifts associated with short-throw wide-angle lenses while still allowing an ultra-thin design implementation. In the absence of such a long distance from the lens assembly to the first mirror, a complex lens design must be used to magnify the image. Certain prior art lens assemblies having a corresponding complex lens design consist of more than 25 lens elements. Such intricate lens assemblies are naturally very costly and in addition are sensitive to alignment issues and to the distortions each optical element introduces into the output image.

In addition, the various novel embodiments and related implementations of the RPDS described herein have an improved capability to dissipate heat. The position of the light engine near the upper portion of the housing is advantageous over conventional RPDS designs with regard to heat dissipation. In conventional RPDS designs, normally the light engine is positioned generally at the bottom of the housing where the display system sits on a tabletop. The dissipation of heat in these cases is much more difficult, requiring forced-air cooling.

Furthermore, the various novel embodiments and related implementations of the RPDS described herein do not require a complex combination reflection and refraction Fresnel lens that is placed near the screen. FIG. 4 is a sketch of the transition region of a complex hybrid Fresnel lens used in some prior art ultra-thin RPDS designs. The structure is varied from top to bottom as can be seen from the figure. In order to redirect light rays of all impinging angles towards the screen normal, the Fresnel lens 70 of FIG. 4, in its transition region, has separate TIR blades for higher angles and refractive blades for lower angles in one pitch as shown in the figure. This gives every pitch a complex structure. In addition, since the average angles of the rays change from top to bottom in consecutive pitches, every pitch needs to be different in shape. Such complex and expensive combination reflective and refractive Fresnel lenses are needed in prior art RPDS designs to make the structure ultra-thin. The estimated retail price of such lenses is about ten times that of the TIR Fresnel lens shown in FIGS. 9-A and 9-B. Other demonstrated thin-housing RPDS designs have used compound Fresnel lenses, with blades fabricated on both sides of the lens. Such lenses are also expensive to make and are, like the hybrid Fresnel, very sensitive to planarity issues, requiring an expensive rigid mounting in the system.

It should be understood that features shown and described in relation to each of the various embodiments and/or implementations may be used in combination or substitution with any features of the other described embodiments and/or implementations, where such a combination or substitution results in a workable arrangement or configuration. Accordingly, this disclosure is contemplated to encompass all such combinations or substitutions resulting in operative embodiments and implementations.

It should be understood that various modifications can be made to the embodiments and/or implementations described and illustrated herein, without departing from the embodiments and/or implementations, the general scope of which is defined in the appended claims.

1. A rear projection display system comprising:
a) a housing;
b) a screen disposed at a front side of the housing;
c) a light engine positioned generally in an upper region of the housing to facilitate heat dissipation, the light engine being adapted to project an off-axis beam of light to form a projected image;
d) a first mirror positioned in a lower region of the housing generally opposite the light engine, the first mirror being adapted to reflect the projected image to form a first reflected image that is reflected upward and away from the screen;
e) a second mirror positioned generally opposite the screen, the second mirror being adapted to reflect the first reflected image to form a second reflected image that is directed towards the screen in an off-axis manner with respect to a screen normal, the second reflected image being formed with light rays having a desired angular range with respect to the screen normal to allow collimation via total internal reflection; and,
f) a total internal reflection Fresnel lens positioned generally parallel and adjacent to the screen, the Fresnel lens being adapted to reflect the light rays of the second reflected image along the direction of the screen normal to form a final image that is displayed on the screen.

2. The system of claim 1, wherein the system has a D-to-d ratio of at least 6:1, where D is the diagonal length of the screen and d is the thickness of the housing.

3. The system of claim 1, wherein the light engine is positioned lower than the top of the screen to reduce the amount by which the top of the housing extends above the top of the screen.

4. The system of claim 1, wherein the first mirror is one of a flat mirror, a cylindrical mirror, a spherical mirror, an aspherical mirror, and a non-rotationally symmetric mirror.

5. The system of claim 1, wherein the second mirror is one of a flat mirror, a cylindrical mirror, a spherical mirror, and an aspherical mirror.

6. The system of claim 1, wherein the second mirror is a non-rotationally symmetric mirror.

7. The system of claim 6, wherein the second mirror has a vertically oriented concave surface and a horizontally oriented surface with a first varying degree of convex curvature on an upper surface that smoothly transitions to a second varying degree of convex curvature on a lower surface for reducing spatial distortion of the final image displayed on the screen.

8. The system of claim 7, wherein the second mirror has a small degree of horizontal convex curvature on an upper portion and a larger degree of horizontal convex curvature on a lower portion for reducing spatial distortion of the final image displayed on the screen.

9. The system of claim 7, wherein the second mirror has a slight vertical concave surface.

10. The system of claim 1, wherein the first mirror has first and second portions, and wherein the first portion is disposed further away from the screen than the second portion and the first portion has a smaller radius of curvature than the second portion.

11. The system of claim 7, wherein the first mirror has first and second portions, and wherein the first portion is disposed further away from the screen than the second portion and the first portion has a smaller radius of curvature than the second portion.

12. The system of claim 1, wherein the first mirror is a flat mirror, and the second mirror is vertically and horizontally convex and is non-rotationally symmetric.

13. The system of claim 1, wherein the desired angular range is from about 34° to 65°.

14. The system of claim 1, wherein the light engine comprises:
g) a light generator to produce a beam of light;
h) at least one micro-display device disposed downstream of the light generator, the at least one micro-display device being adapted to produce a modulated image by modulating the beam of light based on an input image data set; and,
i) a lens assembly disposed downstream of the at least one micro-display device, the lens assembly being adapted to project the modulated image to form the projected image.

15. The system of claim 14, wherein the lens assembly comprises an aspherical rotationally non-symmetric lens being shaped to compensate for defocusing caused by the second mirror.

16. The system of claim 14, wherein the lens assembly consists of only spherical lens elements.

17. The system of claim 1, wherein the system further comprises an image processor connected to the light engine, the image processor being adapted to correct for geometric and optical distortions in the final image.

18. The system of claim 17, wherein the image processor is adapted to correct luminance non-uniformity in the final image.

19. The system of claim 17, wherein the image processor is adapted to perform optical distortion correction for each color component separately to eliminate lateral chrominance distortions in the final image.

20. An optical system for use in a rear projection display system having a housing and a screen, wherein the optical system comprises:
a) a light engine positioned in an upper portion of the optical system, the light engine being adapted to project a beam of light to form a projected image;
b) a first mirror positioned in a lower portion of the optical system, the first mirror being adapted to reflect the projected image to form a first reflected image that is reflected upward and away from the screen;
c) a second mirror positioned to one side of the first mirror, the second mirror being adapted to reflect the first reflected image to form a second reflected image with light rays having a desired angular range with respect to a screen normal of the screen to allow collimation via total internal reflection; and,
d) a total internal reflection Fresnel lens, positioned generally opposite the second mirror, the Fresnel lens being adapted to reflect the light rays of the second reflected image along the direction of the screen normal to form a final image that is displayed on the screen.

21. The optical system of claim 20, wherein the first mirror is one of a flat mirror, a cylindrical mirror, a spherical mirror, an aspherical mirror, and a non-rotationally symmetric mirror.

22. The optical system of claim 20, wherein the second mirror is one of a flat mirror, a cylindrical mirror, a spherical mirror, and an aspherical mirror.

23. The optical system of claim 20, wherein the second mirror is a non-rotationally symmetric mirror.

24. The optical system of claim 23, wherein the second mirror has a vertically oriented concave surface and a horizontally oriented surface with a first varying degree of convex curvature on an upper surface that smoothly transitions to a second varying degree of convex curvature on a lower surface for reducing spatial distortion of the final image.

25. The optical system of claim 23, wherein the second mirror has a small degree of horizontal convex curvature on an upper portion and a larger degree of horizontal convex curvature on a lower portion for reducing spatial distortion of the final image.

26. The optical system of claim 23, wherein the second mirror has a slight vertical concave surface.

27. The optical system of claim 20, wherein the first mirror has first and second portions, and wherein the first portion is disposed further away from the screen than the second portion and the first portion has a smaller radius of curvature than the second portion.

28. The optical system of claim 23, wherein the first mirror has first and second portions, and wherein the first portion is disposed further away from the screen than the second portion and the first portion has a smaller radius of curvature than the second portion.

29. The optical system of claim 20, wherein the first mirror is a flat mirror, and the second mirror is a vertically and horizontally convex and non-rotationally symmetric mirror.

30. The optical system of claim 20, wherein the desired angular range is from about 34° to 65°.

31. The optical system of claim 20, wherein the light engine comprises:
e) a light generator to produce a beam of light;
f) at least one micro-display device disposed downstream of the light generator, the at least one micro-display device being adapted to produce a modulated image by modulating the beam of light based on an input image data set; and,
g) a lens assembly disposed downstream of the at least one micro-display device, the lens assembly being adapted to project the modulated image to form the projected image.

32. The optical system of claim 31, wherein the lens assembly comprises an aspherical rotationally non-symmetric lens being shaped to compensate for defocusing caused by the second mirror.

33. The optical system of claim 31, wherein the lens assembly consists of only spherical lens elements.

34. A method for producing a final image on a screen of a rear projection display system, the display system having a housing, wherein the method comprises:
positioning a light engine in an upper portion of the housing for projecting a beam of light to form a projected image;
positioning a first mirror in a lower portion of the housing for reflecting the projected image to form a first reflected image that is reflected upward and away from the screen;
positioning a second mirror to one side of the first mirror for reflecting the first reflected image to form a second reflected image with light rays having a desired angular range with respect to a screen normal of the screen to allow collimation via total internal reflection; and,
positioning a total internal reflection Fresnel lens generally opposite the second mirror for reflecting the light rays of the second reflected image along the direction of the screen normal to form the final image that is displayed on the screen.

35. The method of claim 34, wherein the method includes providing a non-rotationally symmetric mirror for the second mirror.

36. The method of claim 35, wherein the method includes providing the second mirror with a vertically oriented concave surface and a horizontally oriented surface with a first varying degree of convex curvature on an upper surface that smoothly transitions to a second varying degree of convex curvature on a lower surface for reducing spatial distortion of the final image.

37. The method of claim 36, wherein the method includes providing the second mirror with a small degree of horizontal convex curvature on an upper portion and a larger degree of horizontal convex curvature on a lower portion for reducing spatial distortion of the final image.

38. The method of claim 36, wherein the method includes providing the second mirror with a slight vertical concave surface.

39. The method of claim 34, wherein the first mirror has first and second portions, the first portion being disposed further away from the screen than the second portion and the method includes providing the first portion with a smaller radius of curvature than the second portion.

40. The method of claim 34, wherein the method includes providing a flat mirror for the first mirror, and a vertically and horizontally convex and non-rotationally symmetric mirror for the second mirror.
